(19) United States
(12) Patent Application Publication
(10) Pub. No.: US 2010/0139810 A1
(43) Pub. Date: Jun. 10, 2010

(54) METHOD & DEVICE FOR HIGH TEMPERATURE COMBUSTION APPLICATIONS

(75) Inventor: Christopher William Jorgensen, Queensland (AU)

Correspondence Address: BROOKS KUSHMAN P.C., 1000 TOWN CENTER, TWENTY-SECOND FLOOR, SOUTHFIELD, MI, 48075, US

(73) Assignees: Christopher William JORGENSEN, St Kenmore, QLD (AU); Patrick Clifford JORGENSEN, St Kenmore, QLD (AU)

(21) Appl. No.: 12/526,591

(22) PCT Filed: Feb. 11, 2008
(86) PCT No.: PCT/AU2008/000156

§ 371 Date: Feb. 3, 2010

(30) Foreign Application Priority Data
Feb. 9, 2007 (AU) 2007900638

(51) Int. Cl. B23K 7/00; F23N 1/02; B23K 7/06; F23D 11/44

(52) U.S. Cl. 148/194; 431/12; 266/48; 266/66; 431/207

(57) ABSTRACT

A gas torch assembly and its method of use are described for use in high-temperature applications such as a furnace, power generation station, pottery kiln and flame cutting and welding torches, which requires only inexpensive, low environmental impact, low pressure fuels such as propane gas and air; utilizes the initial internal combustion of the fuel gas to subsequently preheat air/oxygen and/or the fuel gas to well above ambient temperature; and dispenses with the need of arc-oxygen or arc-air cutting of metals.

THIS INVENTION relates to high temperature combustion. In particular, it is directed to a device and its method of use in high-temperature applications such as a furnace, power generation station, pottery kiln and cutting and welding torches. Although in no way limiting, the present invention finds especial use for hand held cutting and welding torches that are fuelled by a combustible gas(es).

Throughout this specification, unless the contrary is expressly stated, where a document, act or item of knowledge is referred to or discussed, this reference or discussion is not an admission that the document, act or item of knowledge or any combination thereof was, at the priority date, publicly available, known to the public, part of the common general knowledge, or known to be relevant to an attempt to solve any problem with which this specification is concerned.

Prior art devices for gas torches essentially simply mix an oxidant, usually air (or oxygen), at ambient temperature with a fuel gas which is then ignited. For relatively low temperature applications (for example, a heat gun to soften and remove paint from a surface), low molecular weight hydrocarbon gases such as propane and butane are used as the fuel; when a much higher temperature is required such as in the cutting of metals, especially steel, the aforementioned low molecular weight hydrocarbons do not burn at a sufficiently high temperature and the fuel of choice is thus, typically acetylene, which is mixed with oxygen rather than air.

Disadvantages of a high-temperature fuel such as acetylene include (i) it is relatively expensive to manufacture and thus purchase; (ii) the inconvenience of having to contain the gas at a relatively high pressure until its point of use; and (iii) any escaped unburnt fuel during use is not environmentally friendly as the gas is reactive in the atmosphere.

Further, as these fuel gases (low or high temperature) are stored under pressure, the consequent relative high density of the fuel gases leads to an inefficient mixing of those gases with the oxidant (air or oxygen) at the immediate point of use and, therefore, the maximum combustion temperature obtainable from the prior art devices is not maximised.

It would thus be advantageous if the required higher temperatures could be obtained by using the less expensive, more environmentally friendly, lower molecular weight hydrocarbons such as propane and butane.

One prior art attempt to achieve this advantage is the device described in UK Patent No. 1,141,461. The device, used for welding or cutting, passes a mixture of pre-heated propane (or propylene) and oxygen through a duct(s) in the body portion of a burner nozzle; the heat for pre-heating is derived from the flame produced by the ignited fuel mixture discharging from the nozzle which travels back along the body of the nozzle, the amount of this heat being determined by the composition of the body portion which requires various nickel coatings dependent on the temperature required.

However, there are some disadvantages of this prior art device which include (a) the requirement of determining the appropriate thickness of nickel coating which consequently leads to a series of nozzles being required to cover various applications of use; (b) the machining required to create the central bores, peripheral longitudinal passages and inwardly inclined bores of the various components of the device; (c) the requirement to use oxygen, and not simply air, in conjunction with the fuel gas; and (d) the combustion process occurs at the point of discharge of the fuel gas/oxidant mixture from the device and thus a significant portion of the thermal energy created by that combustion process dissipates to the external environment which limits the available thermal energy to travel back into the interior of the chamber in order to pre-heat the incoming fuel gas/oxidant mixture and consequently the maximum temperature that can be obtained from the combustion of the fuel gas/oxidant mixture is still limited.

It is thus a general object of the present invention to overcome, or at least ameliorate, one or more of the disadvantages of this prior art.

Therefore, according to a first aspect of the present invention, there is provided a combustion process of the type where a fuel gas is mixed with an oxidant gas to form a combustible mixture which is subsequently ignited for use in high-temperature applications such as a furnace, power generation station, pottery kiln and cutting and welding torches, characterised in that, thermal energy generated at the point of ignition from a portion of a thus ignited mixture within a combustion chamber is used to raise the combustion temperature of subsequently ignited said mixture.

In a first embodiment of the present invention, said combustible mixture is provided in a single flow. In this embodiment, said thermal energy is imparted to a pre-ignited said mixture of a further of said single flow.

In a second embodiment of the present invention, said combustible mixture is provided in a multiple of flows. In this embodiment, said thermal energy from one of said flows is imparted to a pre-ignited said mixture of another of said flows.

Said thermal energy may be imparted to said fuel gas or to said oxidant gas or to a combination thereof.

Preferably, said fuel gas is a low-molecular weight hydrocarbon.

Preferably, said low-molecular weight hydrocarbon is selected from the group comprising propane and butane.

Preferably, said oxidant gas is selected from the group comprising air and oxygen.

Optionally, said fuel gas and/or said oxidant gas is/are supplied from a pressurised source.

Although not wishing to be bound by theory, it is believed that by imparting thermal energy to a fuel gas and/or oxidant gas within a combustion chamber prior to ignition, particularly when one or both of said gases are supplied to the combustion chamber from a pressurised source, the density of the subsequent mixture just prior to ignition is lowered which results in a more uniform mixing of the component gases which, in turn, leads to a more efficient combustion and thus a higher combustion temperature.

The hereinbefore described method of the present invention is of use in a furnace, power generation station, pottery kiln and cutting and welding torches and other applications where a high temperature is required.

Therefore, as a second aspect of the present invention, there is provided a device for use in high-temperature applications such as a furnace, power generation station, pottery kiln and cutting and welding torches and the like where a fuel gas is mixed with an oxidant gas to form a combustible mixture which is subsequently ignited, wherein thermal energy generated at the point of ignition from a portion of a thus ignited said mixture within a combustion chamber of said device is used to raise the combustion temperature of subsequently ignited said mixture.

It has been established that the higher temperatures obtained by using a device as hereinbefore described are close to, at or exceed the melting point of typical metals that are required to be cut during construction, engineering or other processes. At these higher temperatures, oxygen present in the air surrounding the metal to be cut can chemically combine with the metal, oxidising the metal, the oxidation product then flowing out of the cut. Such a method is generally known in the art as “oxygen cutting”; however, the prior art methods require an electrical arc to be formed through the air from the exiting nozzle (the electrode) of the cutting torch to the surface being cut. The present invention does not require this electrical arc.

Accordingly, as a third aspect of the present invention, there is provided a method of cutting metal, said method including using a device as hereinbefore described.

Preferably, said method of cutting metal consists of:
providing a device as hereinbefore described;
igniting said combustible mixture; and
subsequently guiding said device along the required line of metal to be cut sufficient to oxidize said metal along said required line.

Preferred embodiments of the present invention will now be described with reference to the accompanying drawings, wherein:

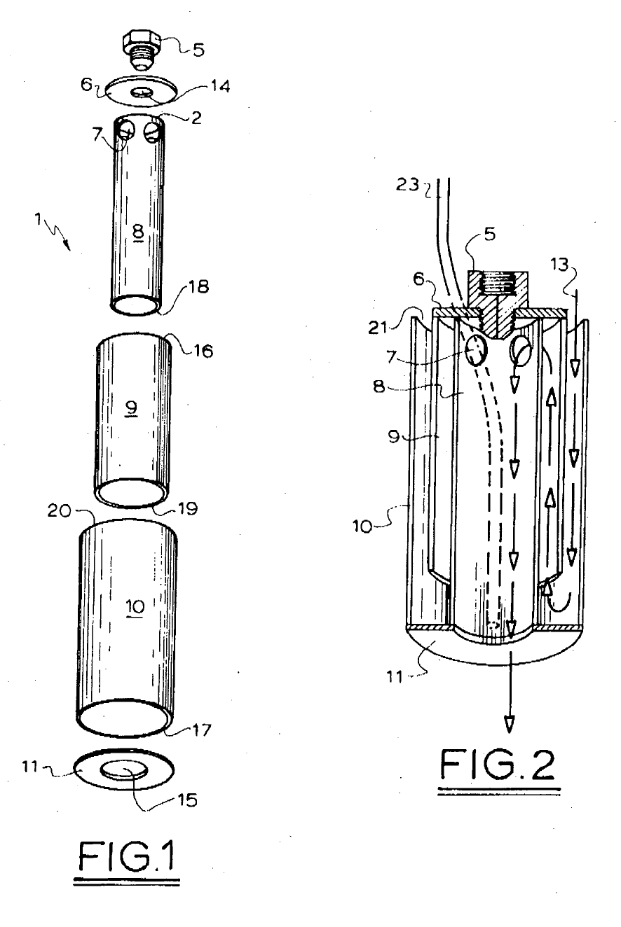

FIG. 1 is an exploded view of a first embodiment of a device constructed in accordance with the present invention;

FIG. 2 is a sectional view of the device of FIG. 1 with an optional feature added;

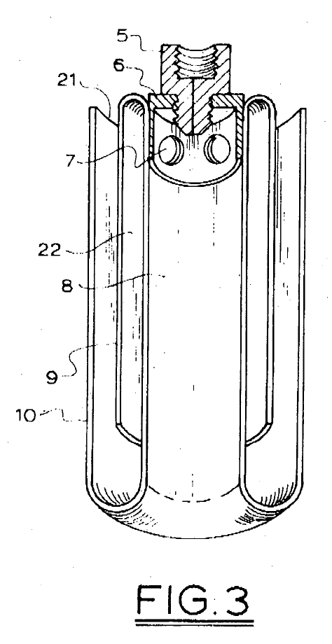

FIG. 3 is a sectional view of a second embodiment of a device constructed in accordance with the present invention;

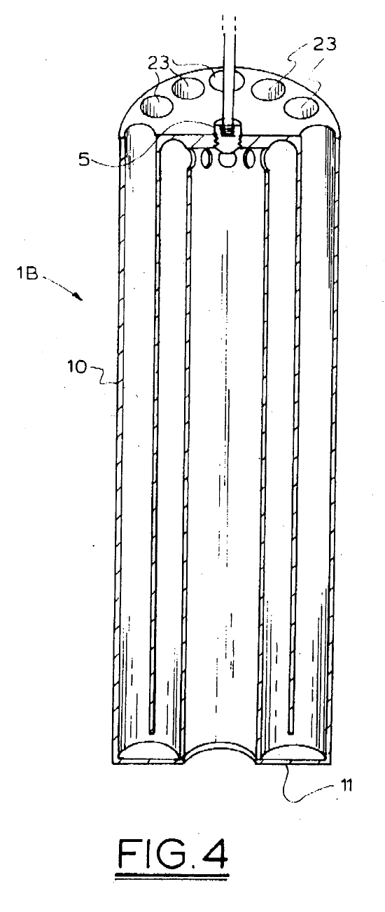

FIG. 4 is a sectional view of a third embodiment of a device constructed in accordance with the present invention;

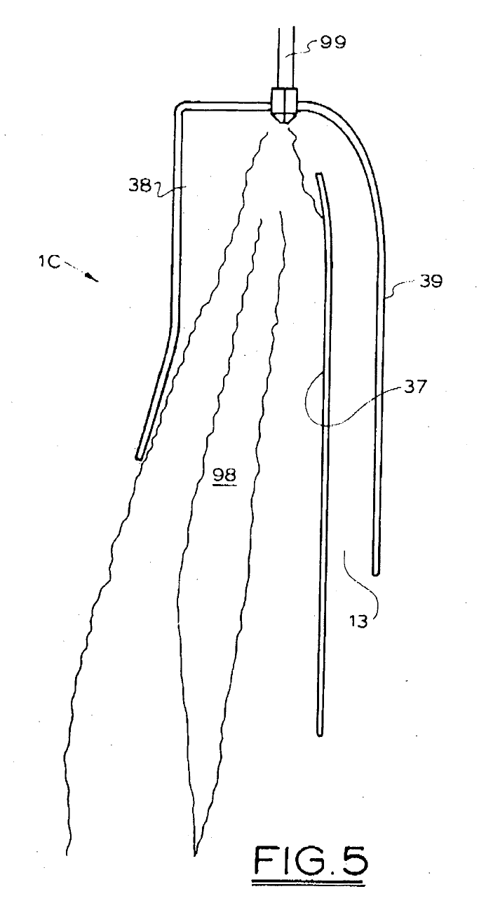

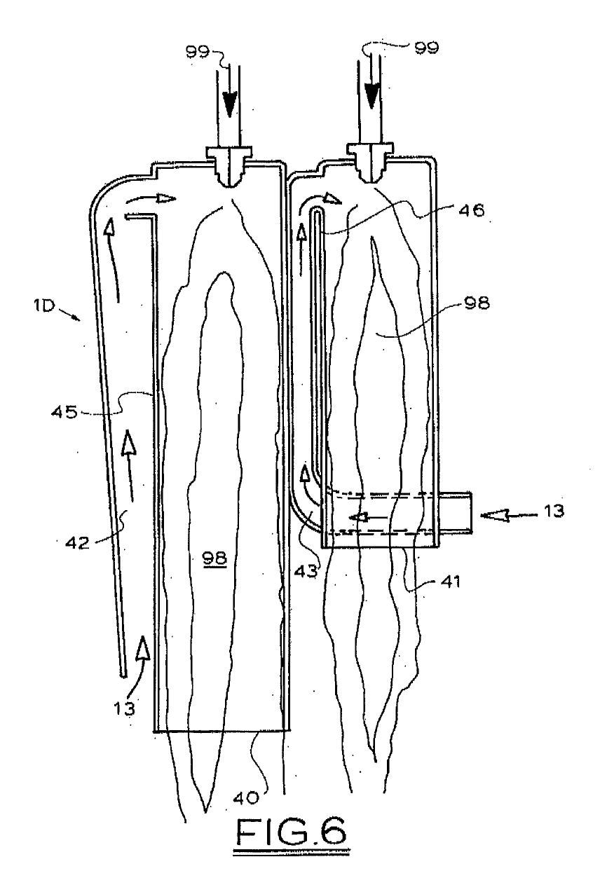

FIG. 5 is a sectional view of a fourth embodiment of a device constructed in accordance with the present invention;

FIG. 6 is a sectional view of a fifth embodiment of a device constructed in accordance with the present invention; and

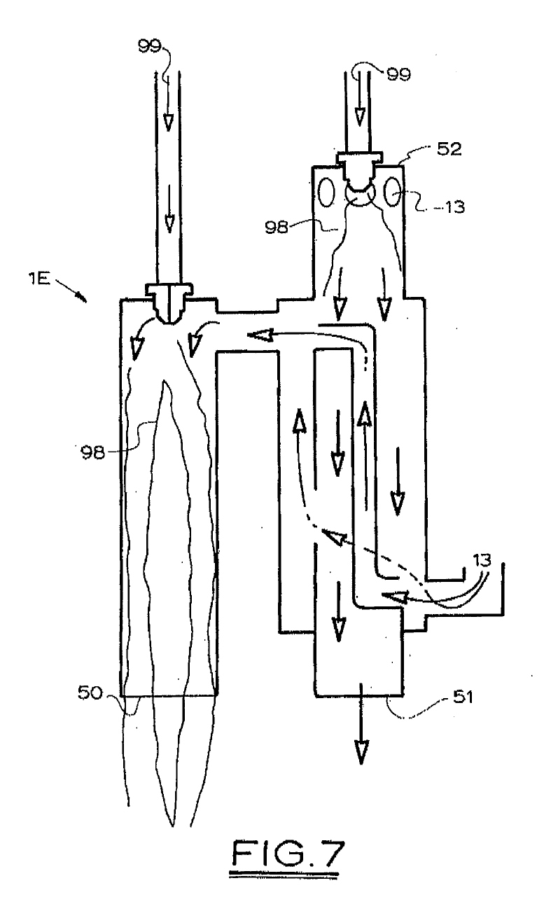

FIG. 7 is a sectional view of a sixth embodiment of a device constructed in accordance with the present invention.

With reference to FIG. 1, the gas torch device (1) includes a nesting of concentric first, second and third hollow tubular bodies (8,9,10) respectively. The first body (8) has four bores (7) positioned substantially equidistant around its perimeter near its inlet end (2). A first washer-type end cap (6) with a central bore (14) is of an external diameter substantially equal to the external diameter of the second body (9). A second washer-type end cap (11) with a central bore (15) is of an external diameter substantially equal to the external diameter of the third body (10). The end (2) of the first body (8) and the end (16) of the second body (9) are fused to the undersurface of the first end cap (6). The end (17) of the third body (10) and the end (18) of the first body (8) are fused to the upper surface of the second end cap (11). The dimensions of the first, second and third bodies (8,9,10) are such that, once the assembly is fitted together (FIG. 2), the end (19) of the second body (9) is spaced from the upper surface of the second end cap (11); the length of the third body (10) and the external diameter of its end (20) are such that a first annular space (21) (as viewed in top plan) is formed around the perimeter of the first end cap (6); and the second body (9) is spaced from the first body (8) to form a second annular space (22) (as viewed in top plan). The bore (14) of the first end cap (6) is threaded to accommodate a complementary threaded connector (5) which, in turn, is connected to a source of fuel gas, for example, a pressurised cylinder of propane gas (not illustrated).

Optionally (FIG. 2), a hollow tube (23) is adapted to pass through the first end cap (6) into the interior of the first body (8) to terminate a short distance before the upper surface of the second end cap (11). The tube (23) is connected to a source of air which may or may not be pressurised, dependent on the use of the device (1).

In use (FIG. 2), fuel gas such as propane is fed into the interior of the first body (8). The flow of the gas creates a low pressure region within the interior of the body (8) and thus ambient air (13) is drawn into the assembly (1) through the annular space (21) (the “venturi” effect). The air (13) then flows into the annular space (22) and through the bores (7) into the interior of the first body (8) where it mixes with the incoming propane. On ignition of the propane/air mixture within the first body (8), the flame subsequently exits the bore (15) of the second cap (11) to be used for welding or cutting purposes as required. Upon ignition, the resultant combustion continuously heats the incoming air (13) and propane gas by thermal conduction to well above ambient temperature, sufficient for most welding-type purposes. When even higher temperatures are required, for example, the cutting of steel, pressurized air is passed through the tube (23) into the body (8), this additional pressurised air also being heated by the combustion process occurring within the body (8).

Referring now to FIG. 3, the gas torch device (1A) is very similar to the device (1) described above with reference to FIGS. 1 & 2, except that the bodies (8,9,10) and consequent spaces (21,22) are machined from a single block of material, but still retaining a separate inlet first end cap (6) and connector (5).

FIG. 4, illustrates a third embodiment of a gas torch device (1B) whereby, once again, the assembly is principally manufactured from a single block of material, the separate first end cap (6) of the previous embodiments being replaced by a series of bores (23) in one end of the material with the connector (5) also embedded within the block of material at that end and retaining the separate second end cap (11).

FIG. 5, illustrates a fourth embodiment of a gas torch device (1C). Fuel gas (99) is fed into a first body (38) and air (13), essentially at ambient temperature, is fed through an internal second body (39) passing along a substantial length of the body (38) to mix with the fuel gas (99) whereupon it can be ignited. As the flame (98) burns, thermal energy is passed to further incoming air (13) by conduction through an inner wall (37) within the body (38).

FIG. 6, illustrates a fifth embodiment of a gas torch device (1D) whereby a first body (40) is fused to a second body (41). A first stream of fuel gas (99) is fed into the first body (40) and air (13), essentially at ambient temperature, is fed through an internal first second body (42) passing along a substantial length of the first body (40) to mix with the fuel gas (99) whereupon it can be ignited. A second stream of fuel gas (99) is fed into the second body (41) and air (13), also essentially at ambient temperature, is fed through an internal second second body (43) passing along a substantial length of the second body (41) to mix with the fuel gas (99) whereupon it can be ignited.

The configuration of the various components of this fifth embodiment are such that some of the thermal energy generated by the flame (98) burning within the first body (40) is passed to the subsequent incoming air (13) within its second body (42) by conduction through their common wall (45), thus raising the temperature of the subsequent incoming air (13). Other of the thermal energy generated by the flame (98) burning within the first body (40) is passed to the incoming air (13), and thus raising its temperature, within the second body (43) of the body (41) by conduction through their common wall (44). Similarly, some of the thermal energy generated by the flame (98) burning within the body (41) is passed to the subsequent incoming air (13) within its second body (43) by conduction through their common wall (46), thus raising the temperature of the subsequent incoming air (13).

FIG. 7, illustrates a sixth embodiment of a gas torch device (1E). Fuel gas (99) and air (13) are combusted in a chamber (52). The heat of combustion is passed to a second chamber (51) around which additional air (13), essentially at ambient temperature, is drawn, thus heating this additional air (13). The thus-heated air (13) is passed to a third chamber (50) into which fuel gas (99) is fed and subsequently ignited.

In all of the above-described embodiments, it will be seen that at least some of the thermal energy from at least one combustion process is sacrificed to be imparted to a combustible mixture just prior to ignition of a second combustion process, increasing the efficiency of that second combustion process and thus raising the operating temperature of the gas torch.

The components of the gas torch (1-1E) can be made from any suitable material, such as metal, alloy, ceramic, compound or any composite thereof, that can withstand high temperatures without deformation or decomposition. One such suitable material is nickel alloy. By suitable choice of material, dimension and configuration, significantly higher temperatures can be achieved (in the order of pb 3000° C.) to effectively cut metal by an oxidative reaction without the need of arc-oxygen or air-arc cutting.

The device of the present invention and its potential methods of use thus provide a number of advantages which include:
provides a heating, welding and cutting assembly of cheap and effective construction;
utilizes the initial internal combustion of the fuel gas to subsequently preheat air/oxygen and/or the fuel gas to well above ambient temperature, thus negating the prior-art requirement to use “special” fuel gases for these higher temperatures;
requires only inexpensive, low environmental impact, low pressure fuels such as propane gas and air for all heating and cutting applications; and
dispenses with the need of arc-oxygen or arc-air cutting of metals.

It will be appreciated that the above described embodiments are only exemplification of the various aspects of the present invention and that modifications and alterations can be made thereto without departing from the inventive concept as defined in the following claims.

1. A combustion process of the type where a fuel gas is mixed with an oxidant gas to form a combustible mixture which is subsequently ignited for use in high-temperature applications such as a furnace, power generation station, pottery kiln and cutting and welding torches, characterised in that, thermal energy generated at the point of ignition from a portion of a thus ignited mixture within a combustion chamber is used to raise the combustion temperature of subsequently ignited said mixture.

2. A process as defined in claim 1 wherein, said combustible mixture is provided in a single flow.

3. A process as defined in claim 2 wherein, said thermal energy is imparted to a pre-ignited said mixture of a further of said single flow.

4. A process as defined in claim 1 wherein, said combustible mixture is provided in a multiple of flows.

5. A process as defined in claim 4 wherein, said thermal energy from one of said flows is imparted to a pre-ignited said mixture of another of said flows.

6. A process as defined in claim 1 wherein, said thermal energy is imparted to said fuel gas or to said oxidant gas or to a combination thereof.

7. A process as defined in claim 1 wherein, said fuel gas and/or said oxidant gas is/are supplied from a pressurised source.

8. A process as defined in claim 1 wherein, said fuel gas is a low-molecular weight hydrocarbon.

9. A process as defined in claim 8 wherein, said low-molecular weight hydrocarbon is selected from the group comprising propane and butane.

10. A process as defined in claim 1 wherein, said oxidant gas is selected from the group comprising air and oxygen.

11. A process as defined in claim 10 wherein, when said oxidant is air.

12. A device for use in high-temperature applications such as a furnace, power generation station, pottery kiln and cutting and welding torches and the like where a fuel gas is mixed with an oxidant gas to form a combustible mixture which is subsequently ignited, wherein thermal energy generated at the point of ignition from a portion of a thus ignited said mixture within a combustion chamber of said device is used to raise the combustion temperature of subsequently ignited said mixture.

13. A device as defined in claim 12 which is adapted to be hand held.

14. A device as defined in claim 12 which is adapted to weld metal.

15. A device as defined in claim 12 which is adapted to cut metal.

16. A device as defined in claim 15 wherein said oxidant gas is air.

17. A device as defined in claim 12 which includes:
a first hollow body connected at one end to a first end cap and connected at its opposing other end to a second end cap; said first end cap being adapted to allow ingress of a fuel gas into the interior of said first body and said second end cap being adapted to allow egress of said fuel gas from said interior of said first body;
at least one bore extending through said first body at or near said first end cap;
a second hollow body positioned over, substantially concentric with and spaced from said first body, said second body being connected at one end to said first end cap and having its opposing other end spaced from said second end cap; and
a third hollow body positioned over, substantially concentric with and spaced from said second body, said third body being connected at one end to said second end cap and having its opposing other end spaced from said first end cap.

18. A device as defined in claim 17 wherein, said first body includes four of said bore, positioned equidistant around the perimeter of said first body.

19. A device as defined in claim 17 wherein, all components are manufactured individually.

20. A device as defined in claim 17 wherein, all components except said second end cap are manufactured as an integral unit.

21. A device as defined in claim 17 wherein, said first end cap is further adapted to receive a tube to convey a gaseous fluid into said interior of said first body.

22. A device as defined in claim 21 wherein, said tube terminates at or near said second end cap.

23. (canceled)

24. A method of cutting metal which consists of:
providing a device as defined in claim 12;
igniting said combustible mixture; and
subsequently guiding said device along the required line of metal to be cut sufficient to oxidize said metal along said line.
